(19) United States
(12) Patent Application Publication
(10) Pub. No.: US 2008/0158043 A1
(43) Pub. Date: Jul. 3, 2008

(54) Radar device

(75) Inventors: Wataru Ishio, Owari Asahi (JP); Ryoji Fujioka, Kasugai (JP); Yuichi Morikawa, Kamakura (JP)

Correspondence Address: BEYER WEAVER LLP, P.O. BOX 70250, OAKLAND, CA, 94612-0250, US

(73) Assignee: OMRON Corporation

(21) Appl. No.: 11/823,083

(22) Filed: Jun. 25, 2007

(30) Foreign Application Priority Data
Jul. 10, 2006 (JP) 2006-189641

(51) Int. Cl. G01S 13/00

(52) U.S. Cl. 342/54

(57) ABSTRACT

A radar device includes a light projecting part for projecting light to an object, first and second light receiving elements each for outputting a signal according to the quantity of received light flux, and an optical system having a first optical path and a second optical path for guiding reflected light from the object respectively to the first light receiving element and to the second light receiving element. The optical system guides more light flux to the first optical path than to the second optical path corresponding to an incident light flux to the radar device.

This application claims priority on Japanese Patent Application 2006-189641 filed Jul. 10, 2006.

### BACKGROUND OF THE INVENTION

This invention relates to a radar device for measuring the distance to an object outdoors by irradiating near-infrared light or the like to it by using a laser diode and receiving reflected light therefrom through an optical system by using photodiodes.

Distance-measuring apparatus using a radar device for scanning the front outdoors with a laser beam of near-infrared light or the like to detect the presence or absence of an object in front (such as a front-going vehicle, an obstacle or a pedestrian in the case of a vehicle-mounted radar device) from the incident light including reflected light as well as the distance to a detected object have been coming to be popularly used. Conventional radar devices have been for causing a near-infrared light beam emitted from a laser diode to be reflected from an object, leading the reflected light through an optical system to a photodiode and measuring its position based on the interval between the time when the irradiating light is emitted and the time when the reflected light is received (or when the quantity of reflected light has a peak).

Since the PIN photodiode used in a radar device has a low S/N ratio, it has been known to use a converging lens to converge light or to provide an amplifier to the output of the PIN photodiode in order to increase its light receiving sensitivity. Since the background light and the diode noise are also amplified in this case, however, there has been a limit to the detection of reflected light with a low brightness.

For this reason, radar devices using an avalanche diode with a high light receiving sensitivity have been known, as disclosed, for example, in Japanese Patent Publication Tokkai 11-160432. An avalanche diode is basically an element with a high light receiving sensitivity with lower noise than a PIN diode, its light receiving sensitivity being settable within a certain degree according to the provided bias voltage. If the bias voltage is set high, its sensitivity becomes high, and if the bias voltage is set low, its sensitivity can be set low. The radar device disclosed in aforementioned Japanese Patent Publication Tokkai 11-160432 uses an avalanche photodiode with its bias voltage set high such that even reflected light with a low brightness can be used for measuring a distance with a high level of accuracy.

In the outdoor environment in which a radar device of this type is used, however, the variety in the reflectivity of objects and their distances is quite large. In other words, objects having a wide range of reflectivity are scattered over distances of a large range. The intensity of background light also changes significantly between the daytime and nighttime. Thus, the dynamic range of the incident light is extremely wide.

PIN photodiodes and avalanche photodiodes have the problem of saturation of the measured value when a large quantity of light flux in excess of its detection limit is received. Thus, if light receiving sensitivity of the light receiving element is increased in order to detect reflected light with a low brightness outdoors where the dynamic range of the incident light is extremely wide as explained above, reflected light with a high brightness cannot be detected accurately and this causes a drop in the accuracy of measurement of a distance.

If a diaphragm is added to a lens for reducing the quantity of light flux entering the photodiode, the problem of saturation can be solved but it becomes difficult to detect reflected light with a low brightness. If the bias voltage applied to an avalanche photodiode is reduced, the light receiving sensitivity of the avalanche photodiode itself becomes controlled and the problem of saturation of the received light can be eliminated but the parasitic capacitance of the avalanche photodiode itself increases rapidly and the response to high-speed signals becomes poorer and the distance-measuring capability is adversely affected.

### SUMMARY OF THE INVENTION

It is therefore an object of this invention to provide a radar device with a simple structure capable of measuring the position of an object with a high level of accuracy even in an environment where the dynamic range of the incident light is wide.

A radar device of this invention may be characterized as comprising a light projecting part for projecting light to an object, a first light receiving element and a second light receiving element each for outputting a signal according to received light flux and an optical system having a first optical path and a second optical path for guiding reflected light from the object respectively to the first light receiving element and to the second light receiving element, guiding more light flux to the first optical path than to the second optical path corresponding to an incident light flux to the radar device.

In the above, the first and second light receiving elements may each have a different effective light receiving surface area perpendicular to the direction of light flux that is received such that the first light receiving element receives more light flux than the second light receiving element corresponding to an incident light flux to the radar device.

Stated more generally, a plurality of light receiving elements are provided and more light flux is caused to be received by the first light receiving element than the second light receiving element corresponding to a same incident light flux either by making the effective light receiving surfaces of these light receiving elements to be mutually different or by guiding more light flux to the first optical path than to the second optical path and the quantity of light flux received by each of the light receiving elements is detected.

The first light receiving element may be designed to have a first activity range in which signals are outputted proportional to the logarithm of a smaller quantity of light flux, while the second light receiving element has a second activity range in which signals are outputted proportional to the logarithm of a larger quantity of light flux than the aforementioned smaller quantity, the first light receiving element having a higher sensitivity than the second light receiving element. In other words, the invention may be characterized as using a first light receiving element having a first activity range with higher sensitivity and a second light receiving element having a second activity range with lower sensitivity, the optical system causing the quantities of light flux respectively through the first and second optical paths to be different and the light receiving elements being made to have different sensitivity.

For example, the output from the more sensitive first light receiving element is used when incident light with a low brightness is received by the optical system, while the output from the less sensitive second light receiving element is used when incident light with a high brightness is received by the optical system. Thus, signals that are proportional to the logarithm of the quantity of light flux incident to an optical system with a wider dynamic range can be outputted than by merely making the quantities of light flux being received by the photodiodes to be different from each other.

The first and second light receiving elements may respectively comprise an avalanche photodiode (hereinafter referred to as the APD) and a PIN photodiode (hereinafter referred to as the PD). The APD is an element much more sensitive than the PD and is capable of detecting an object from its output signal even if the quantity of flux is very small. The PD, on the other, is superior to the APD in the detection of an object from a large quantity of light flux and there is less of a problem of deterioration in response characteristic against high-speed signals and saturation even if it is set for a low sensitivity.

For example, if the APD is driven by applying a high bias voltage, its parasitic capacitance can be lowered such that measurements of reflected light with low brightness become possible by maintaining response characteristic against high-speed signals. If the PD is used with the amplification of its output lowered, the circuit noise will not be amplified and signals proportional to the logarithm of the light flux can be outputted with the lowering of the S/N ratio controlled.

The optical system according to this invention may include a converging lens for collecting reflected light, with the first light receiving element set at a position having a higher degree of condensation than the second light receiving element.

For example, the output from the first light receiving element positioned at the focus of the converging lens and adapted to receive more light flux is used when incident light with low brightness is received by the optical system, and the output from the second light receiving element displaced from the focus of the converging lens and adapted to receive less light flux is used when incident light with high brightness is received by the optical system. The second light receiving element may be merely added at the side of the first light receiving element so as to make the amounts of light flux received by these light receiving elements to be different.

The invention may be further characterized wherein the first and second optical paths have different transmissivity for light flux. If the optical paths are formed with light guiding tubes, for example, a diffuser may be provided to the second optical path. If the optical paths are formed with a branched light guide, as another example, a material with higher transmissivity may be used for the first optical path and another material with lower transmissivity may be used for the second optical path, in addition to the use of a diffuser. Alternatively, the light projecting end surface of the second optical path may preferably made cloudy.

The first and second optical paths may be formed so as to have different effective light receiving surface areas along the direction of light flux that is received. If the optical paths are formed by using light guiding tubes or a branched light guide, for example, the cross-sectional area of light receiving surface of the second optical path may be made smaller than that of the first optical path. If the optical paths are formed with hollow light guiding tubes with large attenuation on wall surfaces (with no total reflections on the wall surfaces), as another example, the light receiving surface of the first optical path may be in the direction of the light flux while that of the second optical path may be tilted from the direction of the light flux.

The radar device of this invention may further comprise a synthesizing part that outputs a synthesized signal synthesized from outputs from both the first and second light receiving elements such that synthesized signals proportional to the logarithm of the incident light to the optical system over both low brightness and high brightness can be obtained. Output signals from the first light receiving element adapted to receive more light flux than the second light receiving element are used when incident light with low brightness is received by the optical system, and output signals from the second light receiving element adapted to receive less light flux than the first light receiving element are used when incident light with high brightness is received by the optical system. These output signals are combined to form a synthetic signal with an expanded dynamic range. Thus, positions of objects can be accurately measured from such synthesized signals even when incident light with an extremely wide dynamic range is received.

In summary, a plurality of light receiving elements receive different amounts of light flux and their output signals are synthesized to obtain synthesized signals such that a peak of signals from a high reflector can be accurately detected while low reflectors are being detected.

### BRIEF DESCRIPTION OF THE DRAWINGS

FIG. 1A is a block diagram showing the structure of a radar device of this invention, and FIG. 1B shows the connections of the PD and the APD.

FIG. 2 is a block diagram of the optical unit of the radar device.

FIG. 3A shows the relationships between the quantities of light flux received by the photodiodes and the amplifier outputs, and FIG. 3B shows the relationships between the quantities of light flux received by the light receiving lens and the amplifier outputs.

FIG. 4A shows the relationships between the quantities of light flux received by the photodiodes and the digital outputs of the A/D converters, and FIG. 4B shows the relationships between the quantities of light flux received by light receiving lens and the digital outputs of the A/D converters.

FIG. 5 shows the relationship between the amplifier outputs of the light receiving circuits and the positions of objects with different reflectivity.

FIG. 6 is a flowchart of the signal synthesis process carried out by the CPU.

FIGS. 7A and 7B are flowcharts of the trouble detection process by the CPU.

FIGS. 8A and 8B are flowcharts of the temperature compensation process by the CPU.

FIG. 9A is a block diagram of the optical unit according to the second embodiment of the invention, and FIG. 9B is a plan view of its photodiode unit.

FIG. 10 is a block diagram of the optical unit according to the third embodiment of the invention.

FIG. 11 is a block diagram of the optical unit according to the fourth embodiment of the invention.

FIG. 12 is a block diagram of the optical unit according to the fifth embodiment of the invention.

### DETAILED DESCRIPTION OF THE INVENTION

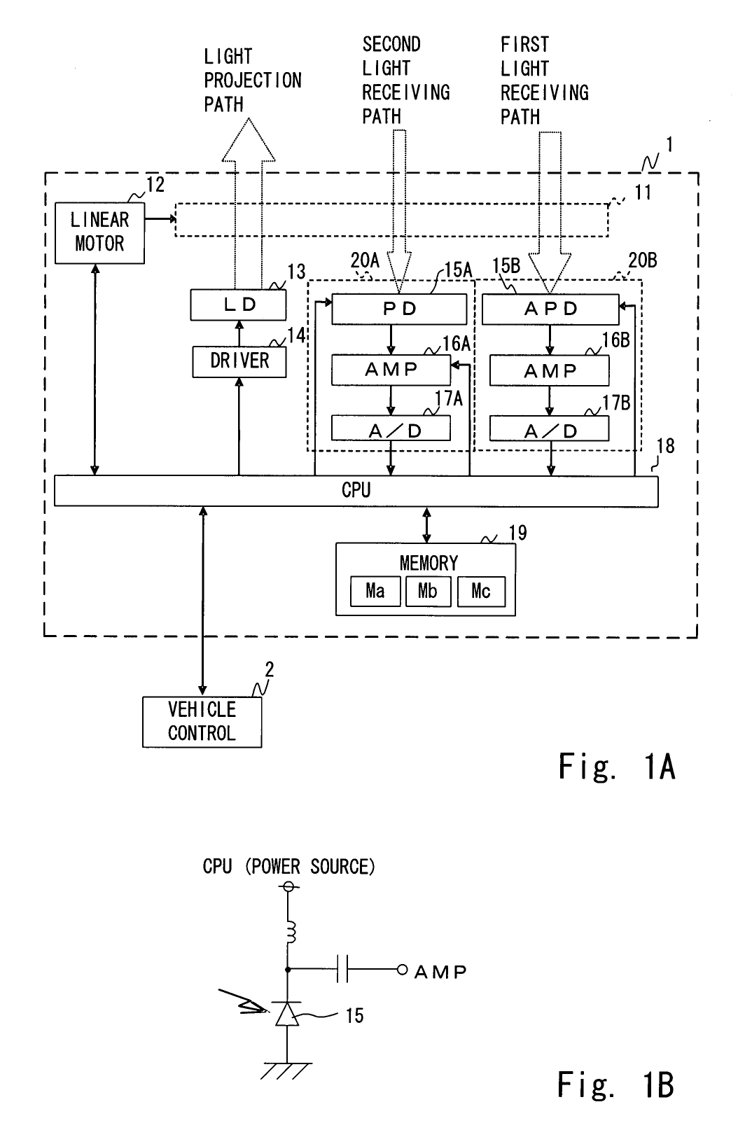

The invention is described next with reference to drawings. FIG. 1A is a block diagram of a radar device 1 comprising an optical unit 11, a linear motor 12, a laser diode (LD) 13, a driver 14, light receiving circuits 20A and 20B, a CPU 18 and a memory 19.

The optical unit 11 has a light projecting path, a first light receiving path and a second light receiving path. The first and second light projecting paths serve to guide light flux from the direction of an object respectively to an avalanche photodiode (APD) 15B and a photodiode (PD) 15A.

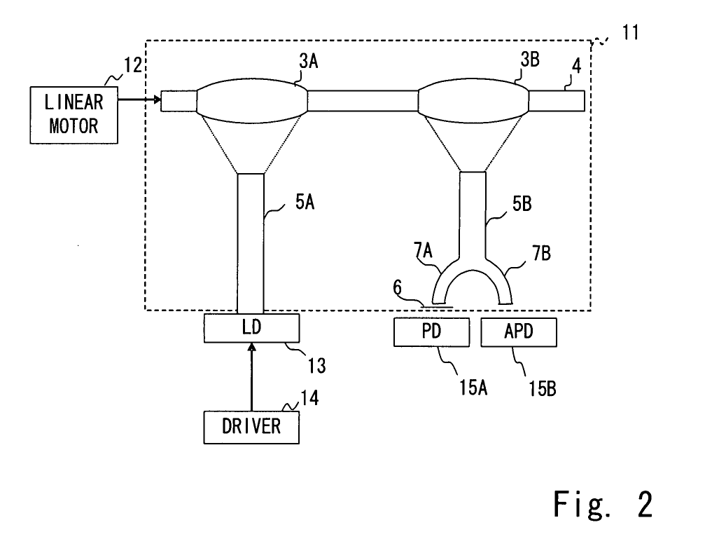

As shown in detail in FIG. 2, the optical unit 11 is provided with a light projecting lens 3A, a light receiving lens 3B, a lens frame 4 that connects these lenses, a light guide 5A having a light projecting surface at the position of the focus of the light projecting lens 3A, another light guide 5B which is a branched light guide serving to branch received light flux evenly into its two branches 7A and 7B and having a light receiving surface at the position of the focus of the light receiving lens 3B, and a diffuser 6 placed at the light projecting surface of the light guide 5B on the side of branch 7A. The diffuser 6 is for reducing the number of received light flux at a specified transmission ratio. The light projecting path is formed with the light guide 5A with its light receiving surface facing the LD 13 and the light projecting lens 3A. The second light receiving path is formed with the light guide 5B having its light projecting surface on the side of branch 7A facing the PD 15A, the diffuser 6 and the light receiving lens 3B. The first light receiving path is formed with the light guide 5B having its light projecting surface on the side of branch 7B facing the APD 15B and the light receiving lens 3B.

In this optical unit 11, the lens frame 4 is connected to the linear motor 12 so as to be connected to the CPU 18 through the linear motor 12 and to oscillate by means of the linear motor 12 to the right and to the left with respect to the direction of motion of the automobile to which the radar device is mounted. The angle of oscillation of the lens frame 4 is set by the control of the CPU 18. A two-dimensional scan can be effected if the angle of oscillation of the lens frame 4 is arranged so as to change vertically in the up-down direction at the ends of its horizontal right-left direction of motion. When the scan is horizontally one-dimensional, it is preferable to project in the forward direction of the automobile an infrared beam which is wide in the vertical direction so as to secure a certain range of light projection in the vertical direction. A scan by the beam may be effected by providing a reflecting mirror and oscillating this reflecting mirror while having the lens frame 4 fixed instead of causing the lens frame 4 to oscillate.

The LD 13 is connected to the driver 14 so as to be connected to the CPU 18 through the driver 14. The LD 13 is a semiconductor infrared laser element adapted to project infrared light controlled by the driver such that its intensity will be as set by the CPU 18. The light guide 5A comprises optical fibers and the infrared light from the LD 13 is received from the light receiving surface facing the LD 13. The light guide 5A serves to guide this infrared light to the light projecting surface facing the light projecting lens 3A which collects the light projected from the light projecting surface and projects it in the forward direction of the automobile as a beam with a specified directionality. Since the lens frame 4 is oscillated by the linear motor 12, as explained above, by a certain angle (such as 20 degrees) to the right and to the left in front of the automobile, this infrared beam is also projected so as to scan an area over an angular range (such as 20 degrees to the right and to the left) and randomly reflected by an object. A portion of this randomly reflected infrared beam is received by the light receiving lens 3B as a reflected beam.

The light receiving lens 3B serves to focus received light such as the reflected beam at its focal point where the light receiving surface of the light guide 5B is positioned. The light guide 5B is a branched light guide such that the light flux received through its light receiving surface is equally divided to its two branches 7A and 7B. The light projecting surface on branch 7A serves to irradiate the diffuser 6 with one half of the light flux received through the light receiving surface, and the diffuser 6 serves to irradiate the PD 15A with a still reduced quantity of light flux. Thus, the transmissivity of the second light receiving path for guiding the incident light from the light receiving lens 3B to the PD 15A is low. By contrast, the light projecting surface of branch 7B irradiates the APD 15B with one half of the light flux received through the light receiving surface and hence the transmissivity of the first light receiving path for guiding the incident light from the light receiving lens 3B to the APD 15B is high.

In summary, since the optical unit 11 is thus structured, a larger quantity of light flux is received by the APD 15B and a smaller quantity of light flux is received by the PD 15A.

The PD 15A is included in the first light receiving circuit 20A and the APD 15B is included in the second light receiving circuit 20B, as shown in FIG. 1A. FIG. 1A also shows that the light receiving circuits 20A and 20B each include an amplifier 16A or 16B and an A/D converter 17A or 17B, respectively. The PD 15A and the APD 15B (both indicated by numeral 15 in FIG. 1B) are each set between the CPU 18 (or a power source controlled thereby) and the ground, having an anode connected on the side of the ground and a cathode on the side of the CPU such that a reverse bias voltage controlled by the CPU 18 is applied. The current generated in the PD 15A by incident light flux to the PD 15A and the APD 15B is outputted from the cathode to the amplifier 16A and the current generated in the APD 15B is outputted from the cathode to the amplifier 16B. The output sides of the amplifiers 16A and 16B are connected to the CPU 18 respectively through the A/D converter 17A or 17B.

The PD 15A and the APD 15B used in the light receiving circuits 20A and 20B are respectively a PIN photodiode and an avalanche photodiode having sensitivity in the infrared region, and a reverse bias voltage somewhat lower than the breakdown voltage is applied to each of them. It is so arranged that if the photoelectric voltage due to incident light with a specified quantity is added to the reverse bias voltage, the total voltage will exceed the breakdown voltage such that a breakdown (or the avalanche phenomenon in the case of the APD) will be caused and a current according to the quantity of light flux will be outputted to the amplifier.

The amplifiers 16A and 16B are variable gain amplifiers, serving to amplify the output currents from the PD 15A and the APD 15B respectively at a gain set by the CPU 18.

The A/D converters 17A and 17B serve to convert (normalize) the amplified outputs respectively of the amplifiers 16A and 16B into a digital output in specified gradations (such as 256 gradations). The level of the amplifier output corresponding to the largest of the specified gradations (such as 256) is set by the A/D converters 17A and 17B as the saturation level of the element (or the upper limit of the level where the amplifier output is in a linear relationship with the logarithm of the quantity of received light), or as the practical upper limit of the quantity of received light. The level corresponding to the smallest value (0) is set as the threshold level (above which an object in front of the automobile can be judged as being present). As a specific example, the CPU 18 may detect the quantity of received light for a plural number of times while light is not being projected. A threshold value may then be obtained by adding their average and a multiple of their fluctuations (standard deviation) by a factor and set to the A/D converters 17A and 17B.

The CPU 18 is connected to the light receiving circuits 20A and 20B, the linear motor 12, the driver 14, the memory 19 and a vehicle control device 2. It indicates the oscillation angle to the linear motor 12 and sets the intensity of projected light to the driver 14.

The CPU 18 controls and sets the activity range of the light receiving circuits 20A and 20B, or in particular the saturation levels of the PD 15A and the APD 15B by adjusting the reverse bias voltage of the light receiving circuits 20A and 20B. The activity range of the light receiving circuits 20A and 20B, and in particular their circuit noise is controlled and set by adjusting the gain of the amplifiers 16A and 16B.

As digital outputs from the light receiving circuits 20A and 20B are inputted, the CPU 18 saves them temporarily in the plurality of memory areas Ma-Mc of the memory 19. The CPU 18 generates a synthesized signal based on the data on the digital outputs stored in the memory 19. Thus, the CPU 18 may also be regarded as a synthesizer of this invention. The CPU 18 further serves to carry out recognition processes based on such synthesized signals, intensity of the projected light and the angle of light projection, as well as calculation processes for the control of the vehicle. The results of these processes are outputted to the vehicle control device 2.

With the radar device 1 thus structured, outputs of the APD 15B are used when light with a low brightness is received through the light receiving lens 3B of the optical unit 11, but outputs of the PD 15A are used when light with a high brightness is received through the light receiving lens 3B such that these outputs are combined to obtain a synthesized signal with a wide dynamic range. Thus, even if the light receiving lens 3B receives light including both high and low brightness components, the position of an object can be accurately measured from such a synthesized signal. With a radar device with such a structure, furthermore, the dynamic range can be expanded merely by using an ordinary structure with a PD and an APD to accurately measure the distance to an object.

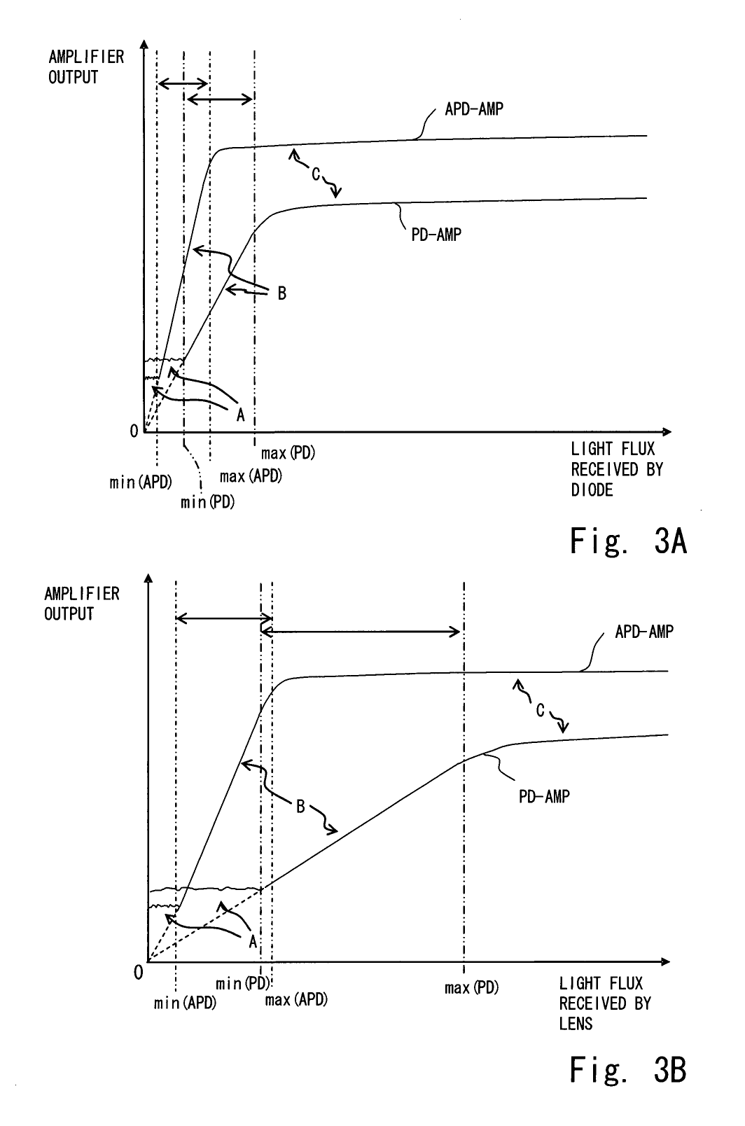

The relationships between the quantities of light flux received by the PD 15A and the APD 15B and the amplifier outputs of the amplifiers 16A and 16B, or the element characteristics of the PD 15A and the APD 15B are shown in FIG. 3A. The relationships between the quantities of light flux received by the light receiving lens 3B and the amplifier outputs of the amplifiers 16A and 16B are shown in FIG. 3B. In these graphs, the horizontal axes show the quantity of light flux logarithmically.

As shown both in FIGS. 3A and 3B, amplifier outputs (both PD-AMP and APD-AMP) include an output waveform A of which the main component is the circuit noise, a saturated output waveform C and a linearly changing output waveform B. Of these output waveforms, it is the linearly changing output waveforms B that indicate the activity range of the corresponding light receiving circuit. The output waveforms A indicate the range of the quantity of light flux which will be determined to be below the threshold level (below min(PD) or min(APD)) by the A/D converters 17A and 17B on the downstream side. The output waveforms C indicate the range of the quantity of light flux which will be determined to be above the saturation level (above max(PD) or max(APD)) by the A/D converters 17A and 17B on the downstream side.

According to the present invention, the light guide 5B serves to guide equal quantities of light flux to the two branches 7A and 7B, and the light flux guided to branch 7A is attenuated by means of the diffuser 6 such that the light flux received by the PD 15A is less than one half of the light flux received by the light receiving lens 3B while the light flux received by the light receiving circuit 20B on the side of the APD 15B is about one half of the light flux received by the light receiving lens 3B. Thus, the practical lower and upper limits min(APD) and max(APD) of the activity range of the light receiving circuit 20B become essentially twice that of the element characteristic of the diode, and the practical lower and upper limits min(PD) and max(PD) of the activity range of the light receiving circuit 20A become greater than twice the element characteristic of the diode.

The upper and lower limits of the activity range of the light receiving circuits, or the upper and lower limits of the linearly changing output waveforms B (min(PD), min(APD), max(PD) and max(APD)), can be preliminarily adjusted by setting the transmissivity of the light receiving path of each light receiving circuit (inclusive of the transmissivity of the diffuser 6). They can be adjusted also by controlling the reverse bias voltages of the photodiodes and the gains of the amplifiers. According to this invention, therefore, gain and bias controls are carried out through the CPU 18, and the diffuser 6 is provided to set the transmissivity of a light receiving path, in order to set the activity ranges of the light receiving circuits. Explained more specifically, the activity range of the light receiving circuit 20A becomes the high brightness range (from medium to high quantity of light flux) by the presence of the diffuser 6 and the bias control of the PD 15A and gain control of the amplifier 16A by the CPU 18, and the activity range of the light receiving circuit 20B becomes the low brightness range (from low to medium quantity of light flux) by the bias control of the APD 15B and gain control of the amplifier 16B. The range of light flux wherein only the light receiving circuit 20A will function (min(APD)-min(PD)), the range of light flux wherein both light receiving circuits 20A and 20B will function (min(PD)-max(APD)), and the range of light flux wherein only the light receiving circuit 20B will function (max(APD)-max(PD)) are arranged to be continuous.

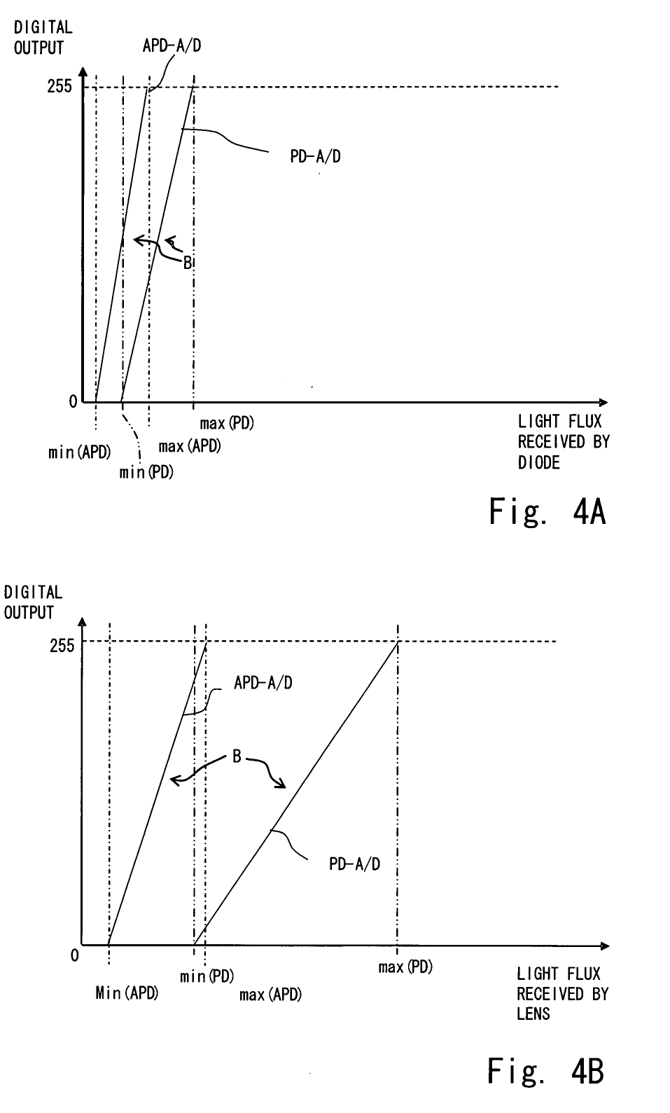

The relationships between the quantities of light flux received by the PD 15A and the APD 15B and the digital outputs of the A/D converters 17A and 17B are shown in FIG. 4A. The relationships between the quantities of light flux received by light receiving lens 3B and the digital outputs of the A/D converters 17A and 17B are shown in FIG. 4B. In these graphs, the horizontal axes show the quantity of light flux logarithmically.

Each of these digital outputs (PD-A/D and APD-A/D) is obtained by converting the amplifier outputs into digital outputs with specified gradations (such as 256 gradations), converting the amplifier output at the lower limit of the quantity of light flux showing the linearly changing output waveform B (min(PD) or min(APD)) to the minimum value of 0 and converting the amplifier output at the upper limit of the quantity of light flux showing the linearly changing output waveform B (max(PD) or max(APD)) to the maximum value of 255.

The lower limit of light flux quantity min(PD) measurable by the light receiving circuit 20A is larger than the lower limit of light flux quantity min(APD) measurable by the light receiving circuit 20B such that reflected light with a low brightness cannot be detected by the light receiving circuit 20A, while the upper limit of light flux quantity max(PD) of the light receiving circuit 20A is larger than the upper limit of light flux quantity max(APD) of the light receiving circuit 20B and the light receiving circuit 20A is capable of detecting reflected light with even an extremely high brightness without saturating. The upper limit of light flux quantity max(APD) of the light receiving circuit 20B is larger than the upper limit of light flux quantity max(PD) of the light receiving circuit 20A such that the light receiving circuit 20B will be saturated by reflected light with a high brightness but the light receiving circuit 20B can detect reflected light with a low brightness because its lower limit of light flux quantity min(APD) is larger than the lower limit of light flux quantity min(PD) of the light receiving circuit 20A.

Thus, since the activity ranges of the light receiving circuits 20A and 20B are overlapped, received light with a medium brightness within the overlapped activity ranges can be measured by each of the light receiving circuits 20A and 20B. Moreover, received light with an extremely low brightness can be accurately detected with the APD of which the sensitivity is set to be high such that more light flux is received, and received light with an extremely high brightness can be accurately detected with the PD of which the sensitivity is set to be low such that less light flux is received.

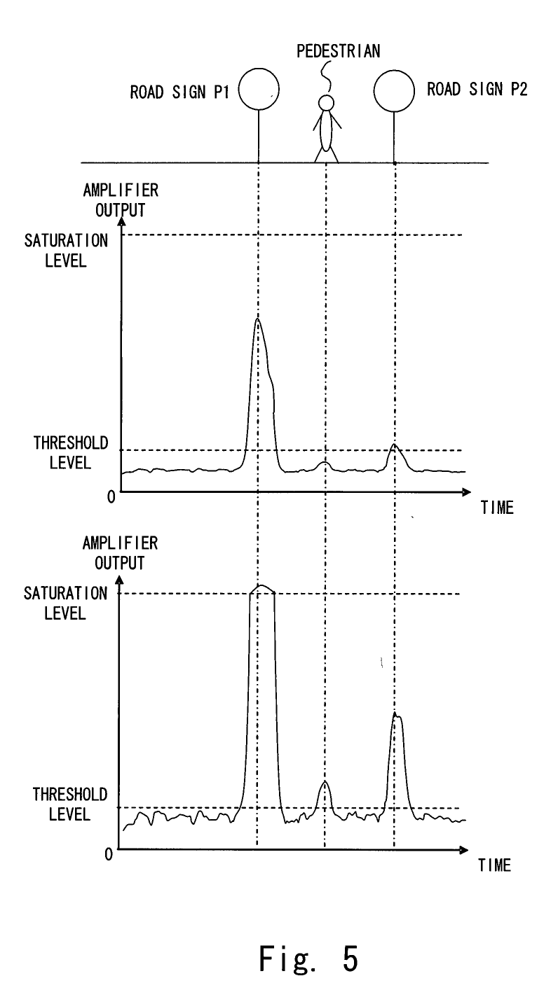

FIG. 5 shows the relationship between the amplifier outputs of the light receiving circuits 20A and 20B and the positions of objects with different reflectivity. Objects in front of the automobile are shown at the top. The amplifier output of the light receiving circuit 20A is shown in the middle and that of the light receiving circuit 20B is shown at the bottom.

The horizontal axes of FIG. 5 indicate the time elapsed from the moment when light is projected (which is an equivalent of the distance from the automobile). The vertical axes indicate the amplifier outputs. FIG. 5 shows an example where there is a road sign P1 as a high light reflector in front of the automobile, a pedestrian as a low light reflector behind it (as seen from the automobile) and another road sign P2 as a high light reflector further behind the pedestrian. It is to be remembered that the received quantity of flux of reflected light decreases proportionally to the fourth power of the distance to the object.

As explained above, the light receiving circuit 20A is provided with a PD and its activity range is set in the range with a high brightness such that its amplifier output due to the reflected light with a high brightness from the road sign P1 with high reflectivity is below the threshold level and the saturation level of the A/D converter 17B. Thus, the light receiving circuit 20A is capable of detecting the peak time when the detected intensity of the road sign P1 becomes a maximum.

As for the pedestrian with low reflectivity, the amplifier output due to the reflected light with a low brightness therefrom becomes below the threshold level during a specified period of time. Thus, the light receiving circuit 20A cannot detect the presence of this pedestrian.

As for the road sign P2 farther away with high reflectivity, the amplifier output due to the reflected light therefrom becomes higher than the threshold value and below the saturation level during a certain period of time. Thus, the light receiving circuit 20A is capable of detecting the peak time when the detected intensity of the road sign P2 becomes a maximum.

As for the light receiving circuit 20B provided with an APD, its activity range is set in the range with a low brightness. In the present example, its amplifier output due to the reflected light from the road sign P1 with high reflectivity becomes higher than the saturation level of the A/D converter 17B. Thus, the light receiving circuit 20B is not capable of detecting the peak time when the detected intensity of the road sign P1 becomes a maximum.

As for the pedestrian with low reflectivity, the amplifier output due to the reflected light with a low brightness therefrom becomes higher than the threshold level and below the saturation level during a specified period of time. Thus, the light receiving circuit 20B is capable of detecting the peak time when the detected intensity of the pedestrian becomes a maximum.

As for the road sign P2 farther away with high reflectivity, the amplifier output due to the reflected light therefrom becomes higher than the threshold value and below the saturation level during a certain period of time. Thus, the light receiving circuit 20B is capable of detecting the peak time when the detected intensity of the road sign P2 becomes a maximum.

In summary, if only the digital outputs of the light receiving circuit 20A were observed, the CPU 18 would not be able to detect any value above the threshold value of the pedestrian, judging that the pedestrian is not present. If only the digital outputs of the light receiving circuit 20B were observed, on the other hand, the CPU 19 would be incapable of detecting the peak of the road sign P1 and hence detecting an accurate distance thereto. According to the present invention, the digital outputs of both light receiving circuits 20A and 20B are recorded in the memory areas Mb and Mc of the memory 19 for carrying out a process of signal synthesis, which is a process of generating a synthesized signal from the digital outputs recorded in the memory 19.

FIG. 6 is a flowchart of this signal synthesis process carried out by the CPU 18.

In this process, the CPU 18 firstly orders the projection of light to the driver 14 (Step S11), causing the LD 13 to emit an infrared beam. The CPU 18 applies reverse bias voltages to the PD 15A and the APD 15B such that the light receiving circuits 20A and 20B will have the activity ranges as described above and sets the gains of amplifiers 16A and 16B such that the PD 15A and the APD 15B will receive light from the forward direction within the activity ranges described above and output electrical signals (Steps S12A and S12B). These electrical signals are amplified by the amplifiers 16A and 16B and converted into digital outputs by the A/D converters 17A and 17B. The CPU 18 stores these digital outputs of the light receiving circuits 20A and 20B in the memory areas Mb and Mc of the memory 19, respectively (Steps S13A and S13B).

Thereafter, the CPU 18 judges whether the maximum value 255 is stored in memory area Mc (as the digital output from the APD) or not (Step S14). If the value stored in the memory area Mc is less than 255 (NO in Step S14), it is judged that a signal below the saturation level (such as from the pedestrian or the road sign P2 in the example shown at the bottom of FIG. 5) and the data in the memory area Mc (or the digital output from the APD) are read out (Step S15C). If the value stored in the memory area Mc is 255 (YES in Step S14), it is judged that a signal above the saturation level has been obtained as the digital output from the APD (such as from the road sign P1 in the example shown at the bottom of FIG. 5) and the data in the memory area Mb (or the digital output from the PD) are read out (Step S15A).

In this situation, since the actually received quantity of reflected light corresponding to the data in the memory area Mb (or the digital output from the PD) is smaller (or 1/16 in the present example) than the actually received quantity of reflected light corresponding to the data in the memory area Mc (or the digital output from the APD), the data value in the memory area Mb (or the digital output from the PD) is multiplied by the CPU 18 (Step S15B). In the present example where the light receiving circuit 20A with the PD is set to output with 1/16 of the magnitude compared to the light receiving circuit 20B with the APD, the data value of the memory area Mb (or the digital output from the PD) is multiplied by 16.

Thereafter, the CPU 18 stores in memory area Ma the multiplied data value of the memory area Mb or the data value of the memory area Mc as the value of the synthesized signal (Step S16). In other words, the value of the synthesized signal may be written as Ma=max(Mb*16, Mc) where Mc is the value by the APD, Mb is the value by the PD and Ma is the value of the synthesized signal to be stored in memory area Ma.

As calculated above, a synthesized signal accurately reflecting the distribution of the quantity of light flux can be obtained such that even objects that could not be detected due to saturation by the light receiving circuit 20B with the APD can be detected by the light receiving circuit 20A and weak reflected light that could not be detected by the light receiving circuit 20A with the PD can be detected by the light receiving circuit 20B.

Thereafter, the CPU 18 judges whether or not the measurement process of Steps S11-S16 has been repeated for a specified number of times (Step S17). Any number may be selected for this purpose but it may be about 20. If these steps have been repeated for the specified number of times (YES in Step S17), it is judged next whether or not measurements have been made over a specified angle (Step S18). As explained above, the radar device 1 is capable of projecting and receiving an infrared beam in a specified horizontal angle (such as 20 degrees to the right and to the left) in the forward direction of the automobile. The angular resolution may be set according to the required degree of accuracy. In Step S18, it is determined whether or not one scan has been completed. If the scan over the specified angular range has not been completed (NO in Step S18), the CPU 18 drives the linear motor 12 to change the range of measurement and repeats the processes described above.

If measurements over the specified angular range have been completed (YES in Step S18), the CPU 18 carries out the process of recognizing the detected object (Step S19). This recognition process is for judging whether the detected object is a human, a vehicle, a road sign, etc. The CPU 18 estimates the kind of the object from the detected data on the object such as its direction, distance, size and ground speed. This may be done by comparing with data of each kind of objects recorded in the memory 19 and the kind of the object may be estimated if the detected object agrees with any of them. The data on the estimated object such as its direction distance, speed and kind are transmitted to the vehicle control device 2 and used for its cruising control or emergency stopping.

By the processes as described above, the CPU 18 can learn the timing of receiving light from the synthesized signal. In other words, the CPU 18 continues to receive data on the quantity of light flux and records the timing of obtaining them. The CPU 18 can calculate the distance of an object by measuring the difference in the timing of the ordering the projection of infrared light and the timing of receiving light. The CPU 18 judges the timing that indicates a peak in the detected quantity of received light along the time axis as indicating the position of that object and judges it as its distance. Since the CPU 18 can detect the projection angle of the infrared beam, as explained above, it can detect the presence of an object as well as its direction and distance based on such data.

By repeating the detection of an object continuously in time for a plural number of times, the CPU 18 can obtain the speed and direction (or the displacement vector) of the motion of that object. By judging the detected objects having the same displacement vector as being one object, the CPU 18 can also calculate the size (width) of an object. If an automobile speed sensor (not shown) is connected to the CPU 18 to detect the speed of the own automobile, it is also possible to calculate the ground speed of an object. Based on such data, the CPU 18 can judge whether the detected object is a human, a vehicle, a road sign, etc., thereby carrying out the process of recognizing the kind of an object.

After recognizing the kind of an object, the CPU 18 transmits the data on this object (such as its direction, distance, speed and kind) to the vehicle control device 2 on the downstream side. The vehicle control device 2 carries out the cruising control for running the own vehicle to follow a front-going vehicle by maintaining a constant distance in between or stopping suddenly to avoid a contact with a pedestrian, based on such received data on objects. When an emergency stopping is effected, the braking may fail to be timely or the braking may be effected uselessly unless the radar device measures the distance to an object accurately. In the past, radar devices having a sufficient dynamic range so as to be able to detect objects with high reflectivity and low reflectivity at the same time were not available such that pedestrians could not be detected or the position of objects with high reflectivity could not be accurately measured. A radar device of this invention uses simultaneously both an avalanche photodiode with high light receiving sensitivity and a PIN photodiode with low light receiving sensitivity and can widen the dynamic range virtually by synthesizing these detected values.

Even if the photodiodes that are used for the light receiving circuits 20A and 20B are substituted by those having the same sensitivity characteristics, it is possible to widen the dynamic range to measure the distance to an object by varying the quantities of light flux received by these photodiodes through the first and second light receiving paths.

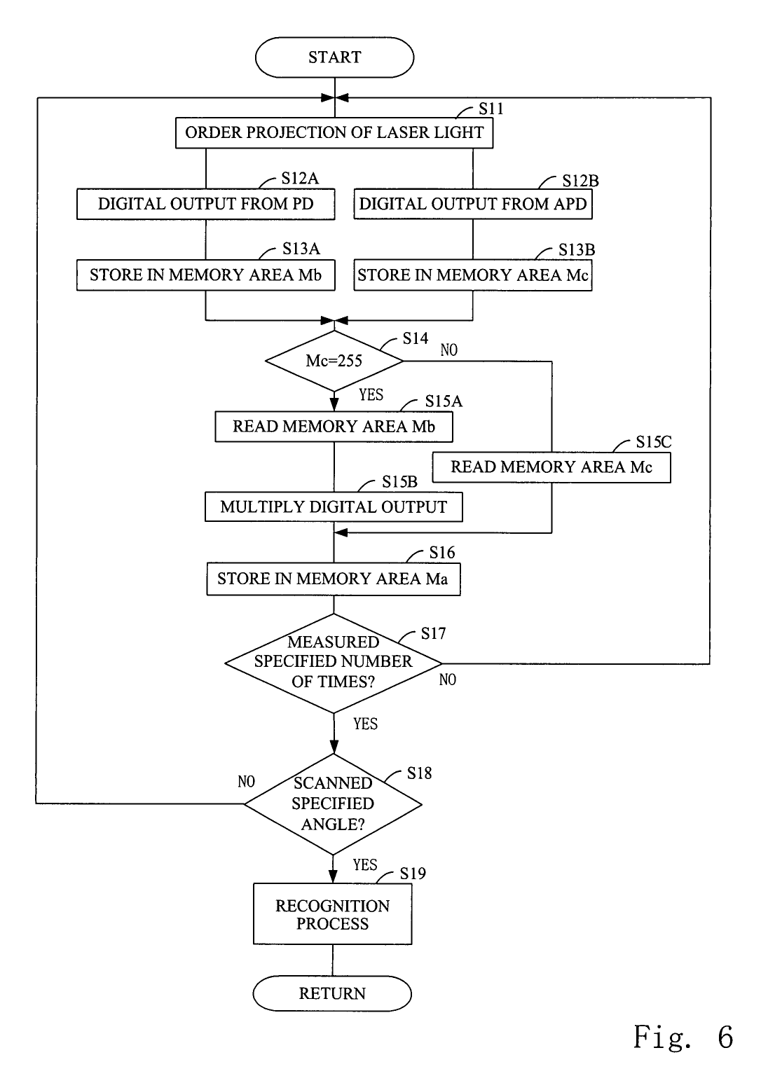

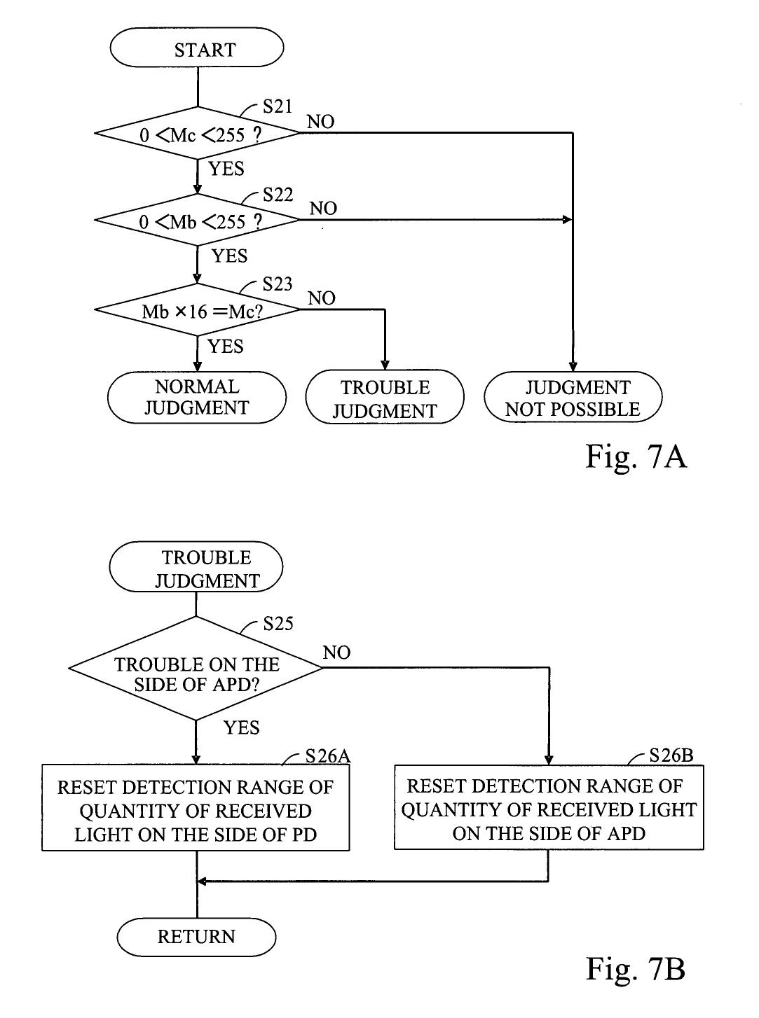

The CPU 18 is further adapted to carry out a trouble detection process. FIG. 7A shows the judgment flow in the trouble detection process, which is carried out by the CPU 18 first by judging whether any data value smaller than the maximum value of 255 and greater than the minimum value of 0 is stored in the memory area Mc (or the digital output from the APD) (Step S21). If the data value stored in the memory area Mc is 255 or 0 (NO in Step S21), the trouble judgment cannot be carried out and hence the process is then terminated.

If the data value stored in the memory area Mc is less than 255 and greater than 0 (YES in Step 21), the CPU 18 judges whether the data value stored in the memory area Mb (or the digital output from the PD) is less than the maximum value of 255 and greater than the minimum value of 0 (Step 22). If the data value stored in the memory area Mb is 255 or 0 (NO in Step S22), the trouble judgment cannot be carried out and hence the process is then terminated.

Next, the CPU 18 compares the data stored in the memory areas Mc and Mb and judges whether the value of the latter is a specified multiple of that of the former (Step S23). If it has been so set that the output of the light receiving circuit 20A provided with the PD is to be 1/16 of that of the light receiving circuit 20B provided with the APD, the data value of the memory area Mb (or the digital output from the PD) is multiplied by its inverse (or 16) for the comparison.

If these values are the same (or approximately the same) (YES in Step S23), both light receiving circuits 20A and 20B may be considered to be operating normally. If they are not the same (NO in Step S23), on the other hand, it may be concluded that at least one of them is in an abnormal condition.

FIG. 7B shows the process by the CPU 18 in the case of the trouble judgment in Step S23. To start, the CPU 18 determines which of the light receiving circuits is in an abnormal condition, say, for the digital output of the waveforms (Step S25).

If the trouble is on the side of the APD, or if it is determined to be the light receiving circuit 20B that is in the abnormal condition (YES in Step S25), the activity range of the light receiving circuit 20A is reset (Step 26A). The reverse bias voltage of the PD 15A may be increased or the gain of the amplifier 16A may be increased so as to increase the light receiving sensitivity of the light receiving circuit 20A such that even reflected light with a low brightness can be detected.

If the trouble is on the side of the PD, or if it is determined to be the light receiving circuit 20A that is in the abnormal condition (NO in Step S25), the activity range of the light receiving circuit 20B is reset (Step 26B). The reverse bias voltage of the APD 15B may be decreased or the gain of the amplifier 16B may be decreased so as to decrease the light receiving sensitivity of the light receiving circuit 20B such that there is no saturation even in the presence of reflected light with a high brightness.

Thus, the current waveforms are compared in the range where the activity ranges of the light receiving circuits 20A and 20B provided respectively with the PD and the APD overlap for detecting abnormality in either circuit. If either of the light receiving circuits is in an abnormal condition, the activity range of the other (normally functioning) light receiving circuit is controlled so as to compensate for that of the light receiving circuit in the abnormal condition. Accordingly, even under a condition where one of the light receiving circuits is in a troubled condition, it is possible to limit the adverse effect on the activity range in which measurements are possible.

Since the variations in the light receiving sensitivity of an APD are generally great with respect to temperature changes, temperature compensation is usually carried out by controlling its bias voltage by means of a temperature sensor. In the case of this invention, too, the output of the light receiving circuit 20B may be stabilized against temperature changes by carrying out temperature compensation by way of the output of a temperature sensor.

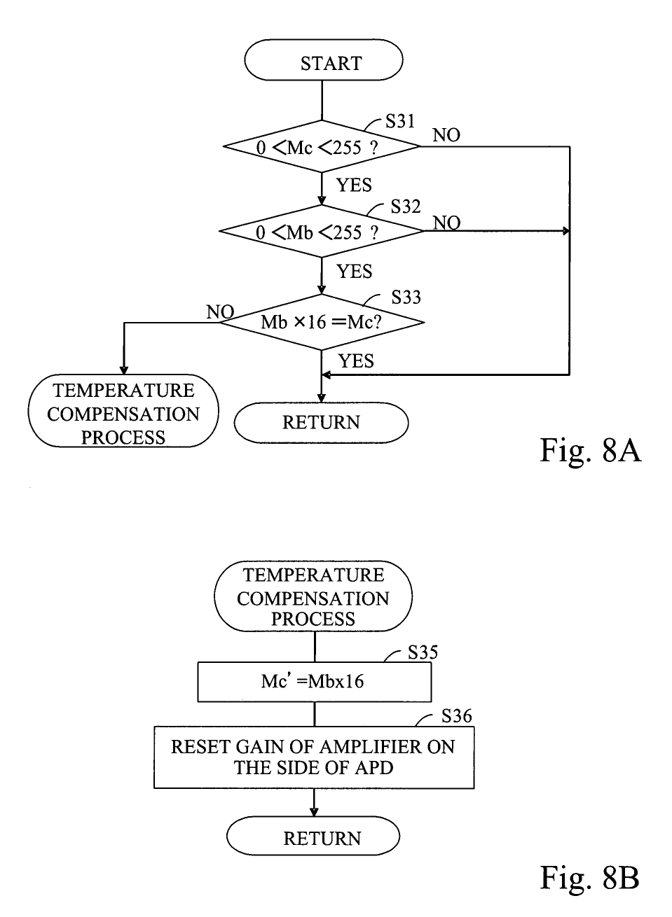

Temperature compensation can be effected in the case of the present invention even without using any temperature sensor. Since the variation in the output of a PD is generally small against temperature changes, the output of the PD can be used for the temperature compensation of the APD. FIGS. 8A and 8B show this process.

To start, the CPU 18 judges whether or not a data value less than the maximum value of 255 and greater than the minimum value of 0 is stored in the memory area Mc (or the digital output from the APD) (Step S31). If the data value stored in the memory area Mc is 255 or 0 (NO in Step S31), the process is terminated because temperature compensation cannot be carried out.

If the data value stored in the memory area Mc is less than 255 and greater than 0 (YES in Step 31), the CPU 18 judges whether or not a data value less than the maximum value of 255 and greater than the minimum value of 0 is stored in the memory area Mb (or the digital output from the PD) (Step S32). If the data value stored in the memory area Mb is 255 or 0 (NO in Step S32), the process is terminated because temperature compensation cannot be carried out.

Next, the CPU 18 compares the data stored in the memory areas Mc and Mb and judges whether the value of the latter is a specified multiple of that of the former (Step S33). If the light receiving sensitivity of the light receiving circuit 20A provided with the PD is set to be 1/16 of that of the light receiving circuit 20B provided with the APD, the data value of the memory area Mb (or the digital output from the PD) is multiplied by its inverse (or 16) for the comparison.

If these values are the same (YES in Step S33), both light receiving circuits 20A and 20B may be considered to be operating normally. If they are not the same (NO in Step S33), on the other hand, it may be concluded that there is a variation in the light receiving sensitivity of the light receiving circuit 20B due to temperature changes and the process shown in FIG. 8B is carried out.

In the temperature compensation process of FIG. 6B, the CPU 18 estimates the digital output in the case where temperature compensation has been accurately carried out by the light receiving circuit 20B on the side of the APD, based on the data stored in the memory area Mb (or the digital output from the light receiving circuit 20A on the side of the PD). Specifically, a value obtained by multiplying the value of the data stored in the memory area Mb by a specified multiplicative factor is defined as the digital output from the light receiving circuit 20B on the side of the APD when temperature compensation has been accurately carried output. If the light receiving sensitivity of the light receiving circuit 20A provided with the PD is set to be 1/16 of that of the light receiving circuit 20B with the APD, the value obtained by multiplying the data value of the memory area Mb (or the digital output from the PD) by its inverse (or 16) is set as the estimated value Mc′ (Step S35).

Next, the CPU 18 compares the estimated value Mc′ with the actual value of the memory area Mc and resets the reverse bias voltage for the APD 15B by calculating the voltage value that would be necessary to make Mc into Mc′ (Step S36). This is how the temperature compensation process may be carried out.

Although an embodiment has been described above wherein light received by the light receiving lens 3B is outputted by branching it to the PD 15A and the APD 15B, this is not intended to limit the scope of the present invention. The invention can be accomplished by using any other kind of optical unit structured such that the PD 15A and the APD 15B will receive different quantities of light flux. For example, a plurality of lenses with different light converging characteristics may be provided such that different quantities of light flux will be received by the PD 15A and the APD 15B. The embodiment shown above having a simple structure with a single lens, however, is preferable.

A second embodiment of the invention is described next. The second embodiment of the invention is different from the first embodiment of the invention described above in that the optical unit and the photodiodes are differently structured. In what follows, the components that are like or equivalent to what have already been described will be indicated by the same numerals and will not be explained repetitiously.

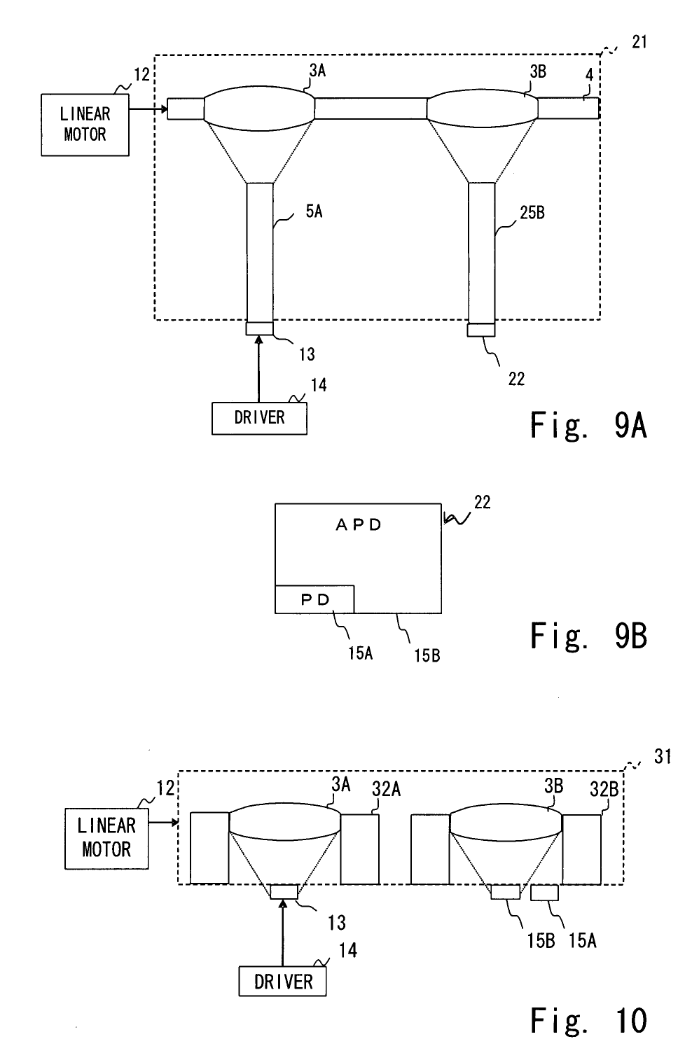

The optical unit according to the second embodiment of the invention is illustrated in FIG. 9A at 21. The light receiving path of the optical unit 21 comprises a light receiving lens 3B and a light guide 25B. The light receiving lens 3B serves to collect received light such as a reflected beam at the position of its focus where the light receiving surface of the light guide 25B is positioned. The light guide 25B comprises optical fibers and its light projecting surface serves to project light as it is received through its light receiving surface.

A photodiode unit 22 is disposed opposite the light projecting surface of the light guide 25B. As shown in FIG. 9B, the photodiode unit 22 comprises the APD 15B and the PD 15A on a single baseboard. The APD 15B and the PD 15A have different light receiving surface areas, that of the APD 15B being larger than that of the PD 15A.

With the optical unit 21 and the photodiode unit 22 thus structured, the APD 15B with a large light receiving surface area receives a larger quantity of light flux while the PD 15A with a small light receiving surface area receives a smaller quantity of light flux. The path of the light flux incident onto the APD 15B is the first light receiving path and that of the light flux incident onto the PD 15A is the second light receiving path. When incident light with a low brightness is received by the light receiving lens 3B of the optical unit 21, use is made of the output from the APD 15B. When incident light with a high brightness is received, use is made of the output from the PD 15A. These outputs are combined to synthesize a synthesized signal with a wide dynamic range. Thus, the position of an object can be accurately measured even when the incident light onto the light receiving lens 3B spans a range from a low brightness to a high brightness.

This embodiment is advantageous in that the structure of a conventional optical unit can be used directly without using any unit with a complicated structure requiring a branched light guide.

It is not necessary, however, to make the light receiving surface areas to be different. For example, an APD and a PD having the same light receiving surface areas may be formed on different baseboards but the direction of the light receiving surface of the PD may be tilted from the direction of the light flux such that the effective light receiving surface area is reduced. In such a case, the radar device can be formed by using light receiving elements of a common structure because the light receiving surface areas of the light receiving elements are not depended upon.

FIG. 10 shows an optical unit 31 according to a third embodiment of this invention, which is different from the optical unit of the first embodiment in that the photodiodes are differently positioned. Like or equivalent components that have already been described are again indicated by the same numerals and will not be described repetitiously.

The light receiving path of this optical unit 31 comprises a light projecting lens 3A and a hollow light guiding tube 32A that holds this lens 3A. Its light receiving path comprises a light receiving lens 3B and a hollow light guiding tube 32B that holds this lens 3B.

The LD 13 is set such that its light projecting surface is at the position of the focus of the light projecting lens 3A, and the APD 15B is set such that its light projecting surface is at the position of the light receiving lens 3B. The PD 15A is set at a side of the APD 15B, displaced from the position of the focus of the light receiving lens 3B. The light receiving lens 3B collects the incident light at the focal position inside the hollow light guiding tube 32B and leaked light irradiates also other positions inside the light guiding tube 32B besides the focal position. The path of the collected light flux received by the APD 15B is the first light receiving path, and the path of the flux of the leaked light received by the PD 15A is the second light receiving path.

With the optical unit 31 thus structured and the PD 15A and the APD 15B thus disposed, the APD 15B at the focal position with a high degree of light convergence receives more light flux and the PD 15A at a position irradiated by leaked light with a small degree of light convergence receives less light flux. If incident light with a low brightness is received by the light receiving lens 3B, use is made of the output from the APD 15B. If incident light with a high brightness is received by the light receiving lens 3B, use is made of the output from the PD 15A. These outputs are combined to synthesize a synthesized signal with a wide dynamic range. Thus, the position of an object can be accurately measured even when the incident light onto the light receiving lens 3B spans a range from a low brightness to a high brightness.

This embodiment is advantageous in that the structure of a conventional optical unit can be used directly without requiring a unit with a complicated structure.

According to the structure of this embodiment, since the relative positions of the lenses 3A and 3B, the LD 13, the PD 15A and the APD 15B must be fixed, the oscillations by the linear motor 12 should preferably be effected on the whole of the optical unit 31.

FIG. 11 shows an optical unit 41 according to a fourth embodiment of this invention, which is different from the optical unit of the first embodiment in that the photodiodes are differently positioned. Like or equivalent components that have already been described are again indicated by the same numerals and will not be described repetitiously.

As shown, the optical unit 41 comprises a light receiving lens 3B and a hollow light guiding tube 42B that holds the lens 3B and is provided with an opening 43 at a portion of its wall surface. The area of the opening 43 is smaller than the sectional area of the tube 42B and its direction is perpendicular to the direction of the tube 42B.

The APD 15B is set such that its light receiving surface is at the focal position of the light receiving lens 3B inside the hollow light guiding tube 42B, and the PD 15A is set on the bottom surface inside the opening 43 of the tube 42B. The light receiving lens 3B converges the incident light such as the received reflected beam at its focus inside the light guiding tube 42B but other portions inside the tube 42B are also irradiated by leaked light. The path of the collected light flux received by the APD 15B is the first light receiving path, and the path of the flux of leaked light received by the PD 15A is the second light receiving path.

With the optical unit 41 thus structured, the APD 15B set on the bottom surface of the light guiding tube 42B receives a larger quantity of light flux while the PD 15A set on the bottom surface of the opening 43, which has a small opening area and makes an angle with the direction of the light guiding tube, receives a smaller quantity of light flux. When incident light with a low brightness is received by the light receiving lens 3B of the optical unit 41, use is made of the output from the APD 15B. When incident light with a high brightness is received by the lens 3B, use is made of the output from the PD 15A. These outputs are combined to synthesize a synthesized signal with a wide dynamic range. Thus, the position of an object can be accurately measured from this synthesized signal even when the incident light onto the light receiving lens 3B spans a range from a low brightness to a high brightness.

According to this embodiment, the dynamic range can be expanded such that the position of an object can be accurately measured simply by providing an opening to the wall surface of a box-like member for holding the lens.

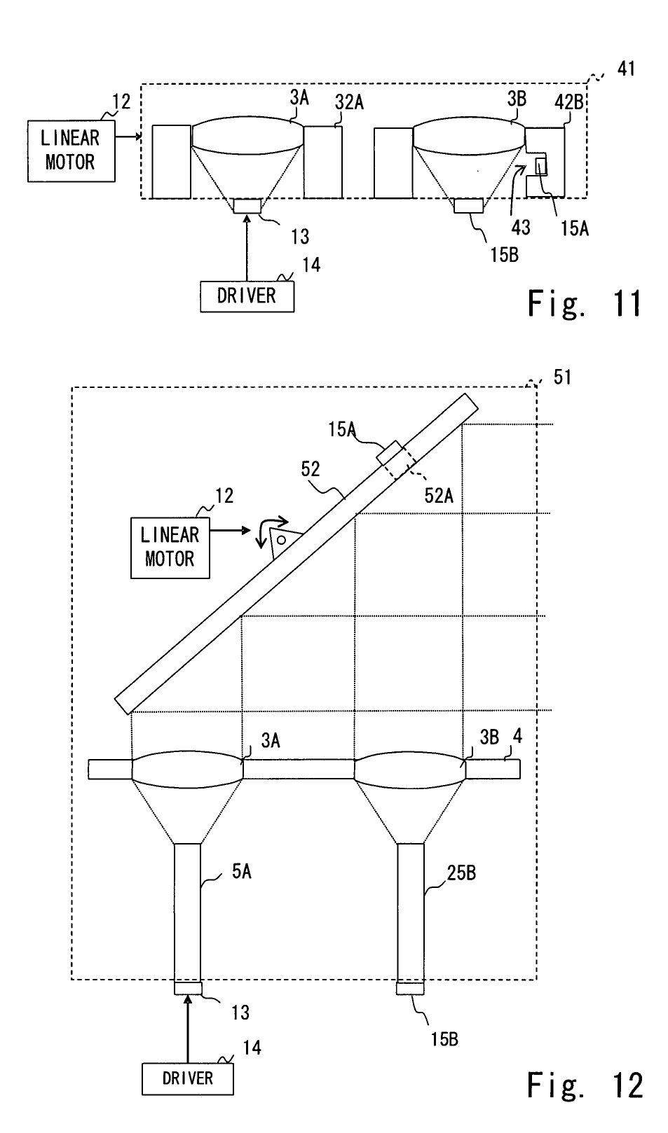

FIG. 12 shows an optical unit 51 according to a fifth embodiment of this invention, which is different from the optical unit of the second embodiment described above in that a reflecting mirror is further included. Like or equivalent components that have already been described are again indicated by the same numerals and will not be described repetitiously.

As shown, the optical unit 51 comprises a reflecting mirror 52, a light receiving lens 3B and a light guide 25B. The reflecting mirror 52 is set at a position such that the infrared beam from the light projecting lens 3A and the reflected beam received by the light receiving lens 3B are reflected. The reflecting mirror 52 is provided with an opening 52A at the position where light from the light receiving lens 3B is reflected. The area of this opening 52A is smaller than the cross-sectional area of the reflected beam received by the reflecting mirror 52.

The PD 15A is set on the bottom surface of the opening 52A and is adapted to receive through this opening 52A leaked portion of the diffused light received by the reflecting mirror from all directions.

The light receiving surface of the light guide 25B is disposed at the focal position of the light receiving lens 3B and the APD 15B is disposed on the light projecting surface of the light guide 25B so as to have a high degree of light convergence.

The sensitive frequency range of both the PD 15A and the APD 15B is set in the infrared range such that an infrared beam can be received efficiently. Since the diffused light received by the reflecting mirror includes background light in the infrared range from all directions in addition to the infrared beam from the direction of an object, it is preferable to set the sensitive frequency range of the PD at frequencies not included so much in the background light. It is also preferable to code-modulate the projected infrared beam and to demodulate received light by the PD 15A and the APD 15B so as to remove the effects of the components of the background light.

The APD 15B receives light flux with a high degree of convergence from the light projecting surface of the light guide 25B with its light receiving surface at the focal position of the light receiving lens 3B, while the PD 15A receives leaked light of the diffused light received by the reflecting mirror.

With the optical unit 51 thus structured, the APD 15B receives a large quantity of light flux converged by the light receiving lens 3B while the PD 15A receives a smaller quantity of light flux of leaked light. The outputs of the APD 15B and the PD 15A are combined to synthesize a synthesized signal. Thus, the position of an object can be accurately measured from this synthesized signal even when the incident light onto the light receiving lens 3B spans a range from a low brightness to a high brightness.

According to this embodiment, the dynamic range can be expanded such that the position of an object can be accurately measured simply by providing an opening to a reflecting mirror and setting the PD on its bottom surface.

Although the invention has been described above by way of a radar device mounted to an automobile, it now goes without saying that this invention can be applied to railroad vehicles and ships as well. Although a radar device using infrared light was disclosed herein, it also goes without saying that this is not intended to limit the scope of this invention. Radar devices for scanning the forward direction with visible light are also within the scope of this invention.

What is claimed is:

1. A radar device comprising:
a light projecting part for projecting light to an object;
a first light receiving element and a second light receiving element each for outputting a signal according to quantity of received light flux; and
an optical system having a first optical path and a second optical path for guiding reflected light from said object respectively to said first light receiving element and to said second light receiving element, wherein said optical system guides more light flux to said first optical path than to said second optical path corresponding to an incident light flux to said radar device.

2. The radar device of claim 1 wherein said first light receiving element has a first activity range in which signals are outputted proportional to the logarithm of a smaller quantity of light flux, and said second light receiving element has a second activity range in which signals are outputted proportional to the logarithm of a larger quantity of light flux than said smaller quantity, said first light receiving element having a higher sensitivity than said second light receiving element.

3. The radar device of claim 1 wherein said first light receiving element is an avalanche photodiode and said second light receiving element is a PIN photodiode.

4. The radar device of claim 1 wherein said optical system includes a converging lens for converging reflected light, and said first light receiving element being set at a position having a higher degree of convergence by said converging lens than said second light receiving element.

5. The radar device of claim 2 wherein said optical system includes a converging lens for converging reflected light, and said first light receiving element being set at a position having a higher degree of convergence by said converging lens than said second light receiving element.

6. The radar device of claim 1 wherein said first optical path and said second optical path have different transmissivity for light flux.

7. The radar device of claim 2 wherein said first optical path and said second optical path have different transmissivity for light flux.

8. The radar device of claim 1 wherein said first optical path and said second optical path have different effective light receiving surface areas along the direction of light flux that is received.

9. The radar device of claim 2 wherein said first optical path and said second optical path have different effective light receiving surface areas along the direction of light flux that is received.

10. The radar device of claim 1 further comprising a synthesizing part that outputs a synthesized signal synthesized from outputs from said first light receiving element and said second light receiving element.

11. The radar device of claim 2 further comprising a synthesizing part that outputs a synthesized signal synthesized from outputs from said first light receiving element and said second light receiving element.

12. A radar device comprising:
a light projecting part for projecting light to an object;
a first light receiving element and a second light receiving element each for outputting a signal according to quantity of received light flux; and
an optical system having a first optical path and a second optical path for guiding reflected light from said object respectively to said first light receiving element and to said second light receiving element, wherein said first and second light receiving elements each have a different effective light receiving surface area perpendicular to the direction of light flux that is received such that said first light receiving element receives more light flux than said second light receiving element corresponding to an incident light flux to said radar device.

13. The radar device of claim 12 wherein said first light receiving element has a first activity range in which signals are outputted proportional to the logarithm of a smaller quantity of light flux, and said second light receiving element has a second activity range in which signals are outputted proportional to the logarithm of a larger quantity of light flux than said smaller quantity, said first light receiving element having a higher sensitivity than said second light receiving element.

14. The radar device of claim 12 wherein said first light receiving element is an avalanche photodiode and said second light receiving element is a PIN photodiode.

15. The radar device of claim 12 wherein said optical system includes a converging lens for converging reflected light, and said first light receiving element being set at a position having a higher degree of convergence by said converging lens than said second light receiving element.

16. The radar device of claim 13 wherein said optical system includes a converging lens for converging reflected light, and said first light receiving element being set at a position having a higher degree of convergence by said converging lens than said second light receiving element.

17. The radar device of claim 12 wherein said first optical path and said second optical path have different transmissivity for light flux.

18. The radar device of claim 13 wherein said first optical path and said second optical path have different transmissivity for light flux.

19. The radar device of claim 12 wherein said first optical path and said second optical path have different effective light receiving surface areas along the direction of light flux that is received.

20. The radar device of claim 13 wherein said first optical path and said second optical path have different effective light receiving surface areas along the direction of light flux that is received.

21. The radar device of claim 12 further comprising a synthesizing part that outputs a synthesized signal synthesized from outputs from said first light receiving element and said second light receiving element.

22. The radar device of claim 13 further comprising a synthesizing part that outputs a synthesized signal synthesized from outputs from said first light receiving element and said second light receiving element.
